(19) United States
(12) Patent Application Publication
(10) Pub. No.: US 2025/0196328 A1
(43) Pub. Date: Jun. 19, 2025

(54) NUMERICAL CONTROL SYSTEM AND ROBOT CONTROL DEVICE

(71) Applicant: FANUC CORPORATION, Minamitsuru-gun, Yamanashi (JP)

(72) Inventor: Kazutaka IMANISHI, Yamanashi (JP)

(73) Assignee: FANUC CORPORATION, Minamitsuru-gun, Yamanashi (JP)

(21) Appl. No.: 18/681,958

(22) PCT Filed: Sep. 30, 2021
(86) PCT No.: PCT/JP2021/036357

§ 371 Date: Feb. 27, 2025

(51) Int. Cl. B25J 9/16

(52) U.S. Cl. CPC B25J 9/1602

(57) ABSTRACT

A numerical control system that controls the operation of a machine tool and the operation a robot in a linked manner, comprising a numerical control device that controls the operation of the machine tool on the basis of a numerical control program, a robot control device that controls the operation of the robot on the basis of a robot control program, a variable storage unit that stores the value of a variable that is readable and writable by the numerical control device, and a signal variable converter that converts the value of the variable of the numerical control device to a signal or a variable for the robot control device, wherein: the robot control device reads out the value of the variable of the numerical control device stored in the variable storage unit; the signal variable converter converts the value of the read-out variable of the numerical control device to the signal or the variable for the robot control device; and the robot control device controls the operation of the robot on the basis of the converted signal or variable for the robot control device.

### TECHNICAL FIELD

The present disclosure relates to a numerical control system and a robot control device.

### BACKGROUND ART

In recent years, in order to promote automation of a machining site, there has been a demand for a numerical control system that controls the operation of a machine tool for machining a workpiece in conjunction with the operation of a robot such as the operation of attaching and detaching a workpiece to and from the machine tool and the operation of opening and closing a door (for example, see Patent Document 1).

Generally, the operation of the machine tool is controlled by a numerical control device and the operation of the robot is controlled by a robot control device. In order to control the operation of the machine tool and the operation of the robot in conjunction with each other or in a cooperative manner, it is necessary to operate both the numerical control device and the robot control device. In this regard, in the numerical control system shown in Patent Document 1, for example, the operation program of the robot can be selected and set in accordance with an command from a user from the numerical control device.

### CITATION LIST

### Patent Document

Patent Document 1: Japanese Unexamined Patent Application, Publication No. 2018-195055

### DISCLOSURE OF THE INVENTION

### Problems to be Solved by the Invention

However, in a numerical control system that controls the operations of the machine tool and the robot in conjunction with each other, when the robot control program is linked via the variables of the numerical control device, the robot control device needs to newly create the robot control program using the variables of the numerical control device. Therefore, the robot control device cannot use the existing robot control program. Therefore, there is a demand for a technology that can use an existing robot control program in a numerical control system that controls operations of a machine tool and a robot in conjunction with each other.

It is an object of the present disclosure to provide a technology that can use an existing robot control program in a numerical control system that controls operations of a machine tool and a robot in conjunction with each other.

### Means for Solving the Problems

A numerical control system according to an aspect of the present disclosure is related to a numerical control system that controls operation of a machine tool and operation of a robot in conjunction with each other, and the numerical control system includes: a numerical control device that controls the operation of the machine tool based on a numerical control program; a robot control device that controls the operation of the robot based on a robot control program; a variable storage unit that stores a value of a variable that is readable and writable by the numerical control device; and a signal variable converter that converts the value of the variable of the numerical control device into a signal or a variable of the robot control device, in which the robot control device reads the value of the variable of the numerical control device stored in the variable storage unit, the signal variable converter converts the value read of the variable of the numerical control device to a signal or a variable of the robot control device, and the robot control device controls the operation of the robot based on the signal converted or the variable converted of the robot control device.

A robot control device according to an aspect of the present disclosure is a robot control device that controls operation of a machine tool and operation of a robot in conjunction with each other based on a robot control program, and the robot control device includes a signal variable converter that converts a value of a variable of the numerical control device that controls the operation of the machine tool based on a numerical control program into a signal or a variable of the robot control device, in which the robot control device reads the value of the variable of the numerical control device from the numerical control device, the signal variable converter converts the value read of the variable of the numerical control device to a signal or a variable of the robot control device, and the robot control device control the operation of the robot based on the signal converted or the variable converted of the robot control device.

### Effects of the Invention

According to the present disclosure, it is possible to use an existing robot control program in a numerical control system that controls the operations of a machine tool and a robot in conjunction with each other.

### BRIEF DESCRIPTION OF THE DRAWINGS

FIG. 1 is a schematic diagram of a numerical control system according to an embodiment of the present disclosure;

FIG. 2 is a functional block diagram of the numerical control system according to the present embodiment;

FIG. 3 is a diagram showing an example of a numerical control program according to the present embodiment;

FIG. 4 is a diagram showing an example of a robot control program created from the numerical control program shown in FIG. 3 using a read/write command of a custom macro variable;

FIG. 5 is a diagram showing a correspondence relationship between conditional branch signals of the robot and values of custom macro variables of the numerical control device;

FIG. 6 is an example of a robot control program including the conditional branch signals of the robot converted by a signal variable converter;

FIG. 7 is a diagram showing a correspondence relationship between values of custom macro variables of the numerical control device and conditional branch signals of the robot;

FIG. 8 is a diagram showing an example of a robot control program created from the numerical control program shown in FIG. 3 using a read/write command of a custom macro variable;

FIG. 9 is a diagram showing a correspondence relationship between conditional branch variables of the robot and values of custom macro variables of the numerical control device;

FIG. 10 is an example of a robot control program including conditional branch variables of the robot converted by the signal variable converter;

FIG. 11 is a diagram showing a correspondence relationship between values of custom macro variables of the numerical control device and conditional branch variables of the robot;

FIG. 12 is a diagram showing another example of the numerical control program according to the present embodiment;

FIG. 13 is a diagram showing an example of a robot control program created from the numerical control program shown in FIG. 12 using a read/write command of a custom macro variable;

FIG. 14 is a diagram showing a correspondence relationship between conditional branch signals of the robot and a value of custom macro variables of the numerical control device;

FIG. 15 is an example of a robot control program including a conditional branch signal of the robot converted by the signal variable converter;

FIG. 16 is a diagram showing a correspondence relationship between values of custom macro variables of the numerical control device and conditional branch signals of the robot;

FIG. 17 is a diagram showing a correspondence relationship between conditional branch variables of the robot and values of custom macro variables of the numerical control device;

FIG. 18 is an example of a robot control program including conditional branch variables of the robot converted by the signal variable converter;

FIG. 19 is a diagram showing a correspondence relationship between values of custom macro variables of the numerical control device and conditional branch variables of the robot; and

FIG. 20 is a flowchart showing a flow of processing for converting a value of a custom macro variable of the numerical control device 2 into a signal or a variable of the robot control device in the numerical control system according to the present embodiment.

### PREFERRED MODE FOR CARRYING OUT THE INVENTION

Hereinafter, embodiments of the present disclosure will be described in detail with reference to the accompanying drawings.

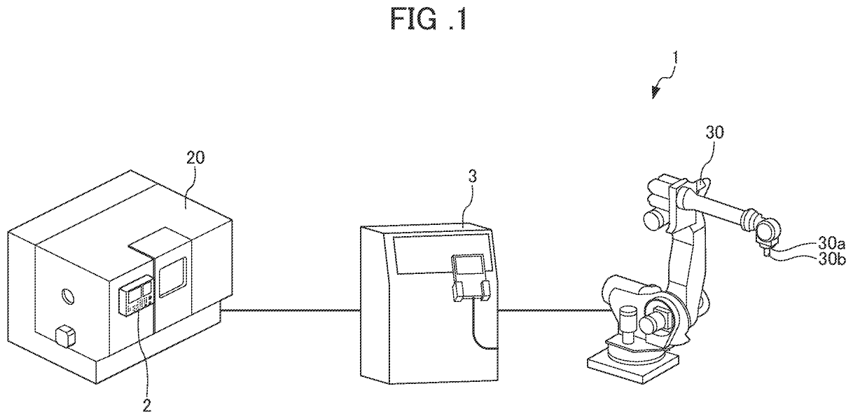

FIG. 1 is a schematic diagram of a numerical control system 1 according to an embodiment of the present disclosure. As shown in FIG. 1, the numerical control system 1 includes a machine tool 20 for machining a workpiece (not shown), a numerical control device (CNC) 2 for controlling the operation of the machine tool 20, a robot 30 provided in the vicinity of the machine tool 20, and a robot control device 3 for controlling the operation of the robot 30. The numerical control system 1 controls the operation of the machine tool 20 and the robot 30 in conjunction with each other by using the numerical control device 2 and the robot control device 3, which are communicably connected to each other.

Examples of the machine tool 20 include a lathe, a ball mill, a milling machine, a grinding machine, a laser processing machine, an injection molding machine, and the like. However, the present disclosure is not limited thereto. The machine tool 20 executes various operations such as a machining operation on a workpiece (not shown), an opening/closing operation of a chuck holding the workpiece, and an opening/closing operation of a door provided in a machining area of the workpiece, in accordance with various command signals transmitted from the numerical control device 2 in accordance with a procedure described later.

The robot 30 operates under the control of the robot control device 3, and performs a predetermined operation on, for example, a workpiece to be machined by the machine tool 20. The robot 30 is, for example, a multi-joint or articulated robot, and a tool 30b for holding, machining, and inspecting a workpiece is attached to an arm tip portion 30a of the robot 30. Hereinafter, although a case where the robot 30 is a six-axis multi-joint robot will be described, the present invention is not limited thereto.

The numerical control device 2 and the robot control device 3 are each a computer including hardware such as an arithmetic processing unit such as a CPU (Central Processing Unit), an auxiliary storage unit such as an HDD (Hard Disk Drive) or SSD (Solid State Drive) storing various programs, a main storage unit such as RAM (Random Access Memory) temporarily storing data required for the arithmetic processing unit to execute programs, an operation means such as a keyboard for an operator to perform various operations, and a display means such as a display for displaying various information for the operator. The numerical control device 2 and the robot control device 3 can transmit and receive various signals to and from each other by Ethernet (registered trademark), for example.

The numerical control system 1 according to the present embodiment includes, for example, one in which the robot 30 is attached to an existing machine tool 20. However, the present invention is not limited thereto. For example, in order to control the operation of the machine tool 20 and the operation of the robot 30 in conjunction with each other, the numerical control system 1 according to the present embodiment is configured such that the robot control device 3 makes an operation request to the numerical control device 2, and the robot control device 3 can read and write variables of the numerical control device 2.

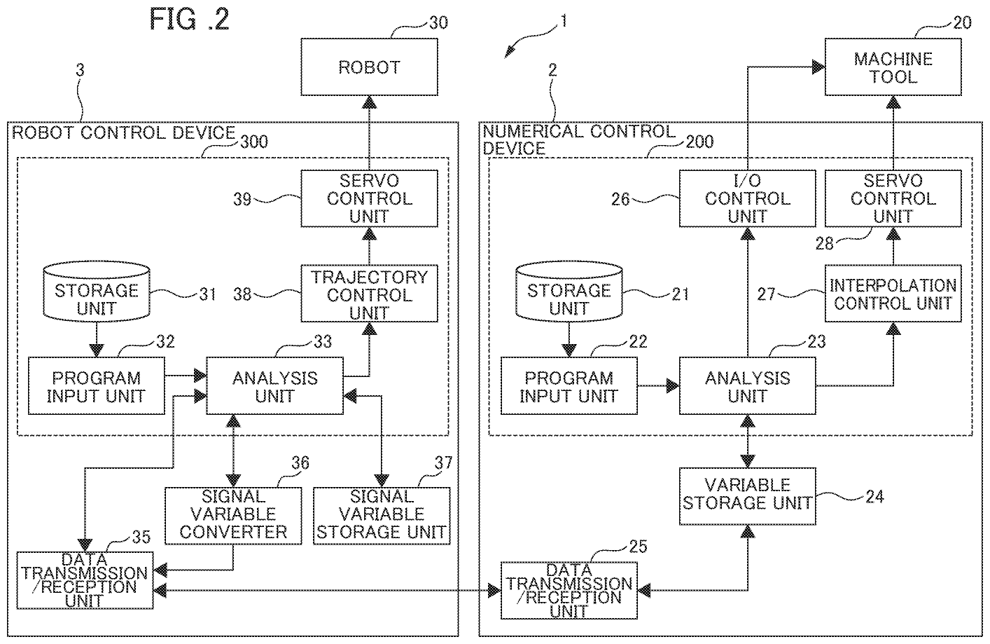

FIG. 2 is a functional block diagram of the numerical control system 1 according to the present embodiment.

First, the detailed configuration of the numerical control device 2 will be described. As shown in FIG. 2, various functions such as a machine tool control module 200 that controls the operation of the machine tool 20, a variable storage unit 24 that stores values of a plurality of variables that can be read and written by the machine tool control module 200 and a robot control module 300 to be described later, and a data transmission/reception unit 25 are implemented in the numerical control device 2 by the above hardware configuration.

The machine tool control module 200 reads and writes values of variables stored in the variable storage unit 24 based on a numerical control program, and controls the operation of the machine tool 20. More specifically, the machine tool control module 200 includes a storage unit 21, a program input unit 22, an analysis unit 23, an I/O control unit 26, an interpolation control unit 27, and a servo control unit 28.

The storage unit 21 stores a numerical control program for controlling the operation of the machine tool 20 (for example, a movement operation of a control axis, a rotation operation of a spindle or main axis, an opening/closing operation of a chuck, an opening/closing operation of a door, and the like are performed). The numerical control program stored in the storage unit 21 is created in advance by an operator in order to control the operation of the machine tool 20 in conjunction with the operation of the robot 30 under the control of the robot control device 3, and is described in a programming language using G code, M code, or the like.

The program input unit 22 reads the numerical control program from the storage unit 21, and sequentially inputs the numerical control program to the analysis unit 23.

The analysis unit 23 sequentially analyzes the command type based on the numerical control program inputted from the program input unit 22 for each block, and transmits the analysis result to the I/O control unit 26, the interpolation control unit 27, and the variable storage unit 24.

When the type of command acquired based on the numerical control program is, for example, a command to open and close the chuck of the machine tool 20 or a command to open and close the door of the machine tool 20, the analysis unit 23 inputs the acquired command to the I/O control unit 26. When the command is inputted from the analysis unit 23, the I/O control unit 26 inputs an I/O signal corresponding to the inputted command to the machine tool 20. With such a configuration, the chuck and door of the machine tool 20 are opened and closed in accordance with a procedure determined by the numerical control program.

When the type of command acquired based on the numerical control program is, for example, a command to move the control axis of the machine tool 20, the analysis unit 23 inputs the acquired command to the interpolation control unit 27. When the command is inputted from the analysis unit 23, the interpolation control unit 27 calculates a movement path of the control axis according to the command by performing interpolation processing, and inputs the calculated movement path to the servo control unit 28. The servo control unit 28 feedback-controls the servo motor of the machine tool 20 so that the control axis moves along the movement path calculated by the interpolation control unit 27. With such a configuration, the operation of the machine tool 20 is controlled by a procedure defined by the numerical control program.

When the type of the command acquired based on the numerical control program is, for example, a command to read the value of the variable stored in the variable storage unit 24 or a command to rewrite the value of the variable stored in the variable storage unit 24, the analysis unit 23 inputs the acquired command to the variable storage unit 24.

The variable storage unit 24 has variable memory (not shown) for storing a plurality of variable values, and reads or rewrites the variable values stored in the variable memory in accordance with a command inputted from the analysis unit 23 or a command inputted from the robot control module 300 described later of the robot control unit 3 via the data transmission/reception unit 25.

In the present embodiment, when a value of the variable assigned to the operation request from the robot control device 3 side to the machine tool 20 is set, the operation completion time is written to the corresponding variable by the machine tool control module 200 and the variable storage unit 24, and the corresponding operation (for example, door opening/closing, chuck opening/closing, machining 1 to 3 described later, and the like) is executed.

The variable memory of the variable storage unit 24 stores values of a plurality of variables designated by numbers or character strings in a numerical control program for controlling the operation of the machine tool 20 in the machine tool control module 200 and a robot control program for controlling the operation of the robot 30 in the robot control module 300. In the present embodiment, as variables stored in the variable memory, a case where a part of custom macro variables (hereinafter, it is also simply referred to as a variable) defined by many numerical control devices (e.g., #100 to #107, #200 to #203) is assigned will be described.

When a command for reading the value of the variable stored in the variable memory is inputted from the analysis unit 23, the variable storage unit 24 reads the value of the variable designated by the command from the variable memory and transmits the read value to the analysis unit 23. When a command for rewriting the value of the variable stored in the variable memory is inputted from the analysis unit 23, the variable storage unit 24 rewrites the value of the variable designated by the command in the variable memory to a value corresponding to the command. With such a configuration, the machine tool control module 200 can read or rewrite the value of the variable stored in the variable memory.

When a command for reading the value of the variable stored in the variable memory is inputted from the robot control module 300 via the data transmission/reception unit 25, the variable storage unit 24 reads the value of the variable designated by the command from the variable memory, and transmits the read value to the robot control module 300 via the data transmission/reception unit 25. When a command for rewriting the value of the variable stored in the variable memory is inputted from the robot control module 300 via the data transmission/reception unit 25, the variable storage unit 24 rewrites the value of the variable designated by the command in the variable memory to a value corresponding to the command. With such a configuration, the robot control module 300 can read or rewrite the value of the variable stored in the variable memory.

The variable memory of the variable storage unit 24 stores values of a plurality of variables assumed to be used for notification or request from the robot control module 300 to the machine tool control module 200; however, the present invention is not limited thereto. Values of a plurality of variables assumed to be used for notification from the machine tool control module 200 to the robot control module 300 may be stored. The variables are preferably readable and rewritable from both the machine tool control module 200 and the robot control module 300.

The variable #100 is assigned, for example, from the robot control module 300 to the machine tool control module 200 to request stopping of the numerical control program being executed in the machine tool control module 200. When the value of the variable #100 is 0, it indicates that the stop of the numerical control program is not requested (request OFF), and when the value of the variable #100 is 1, it indicates that the stop of the numerical control program is requested (request ON).

The variable #101 is assigned, for example, from the robot control module 300 to the machine tool control module 200 to request the opening operation of the door of the machine tool 20. When the value of the variable #101 is 0, it indicates that the door opening operation is not requested (request OFF), and when the value of the variable #101 is 1, it indicates that the door opening operation is requested (request ON).

The variable #102 is assigned, for example, from the robot control module 300 to the machine tool control module 200 to request a closing operation of the door of the machine tool 20. When the value of the variable #102 is 0, it indicates that the door closing operation is not requested (request OFF), and when the value of the variable #102 is 1, it indicates that the door closing operation is requested (request ON).

The variable #103 is assigned, for example, from the robot control module 300 to the machine tool control module 200 to request an opening operation of the chuck of the machine tool 20. When the value of the variable #103 is 0, it indicates that the chuck opening operation is not requested (request OFF), and when the value of the variable #103 is 1, it indicates that the chuck opening operation is requested (request ON).

The variable #104 is assigned, for example, from the robot control module 300 to the machine tool control module 200 to request a chuck closing operation of the machine tool 20. When the value of the variable #104 is 0, it indicates that the chuck closing operation is not requested (request OFF), and when the value of the variable #104 is 1, it indicates that the chuck closing operation is requested (request ON).

The variable #105 is assigned, for example, from the robot control module 300 to the machine tool control module 200 to request execution of machining 1 by the machine tool 20. When the value of the variable #105 is 0, it indicates that the execution of the machining 1 is not requested (request OFF), and when the value of the variable #105 is 1, it indicates that the execution of the machining 1 is requested (request ON).

The variable #106 is assigned, for example, from the robot control module 300 to the machine tool control module 200 to request execution of machining 2 by machine tool 20. When the value of the variable #106 is 0, it indicates that the execution of the machining 2 is not requested (request OFF), and when the value of the variable #106 is 1, it indicates that the execution of the machining 2 is requested (request ON).

The variable #107 is assigned, for example, from the robot control module 300 to the machine tool control module 200 to request execution of machining 3 by the machine tool 20. When the value of the variable #107 is 0, it indicates that the execution of the machining 3 is not requested (request OFF), and when the value of the variable #107 is 1, it indicates that the execution of the machining 3 is requested (request ON).

The variable #200 is assigned, for example, to request an opening operation of the hand 1 of the robot 30 from the machine tool control module 200 to the robot control module 300. When the value of the variable #200 is 0, it indicates that the opening operation of the hand 1 is not requested (request OFF), and when the value of the variable #200 is 1, it indicates that the opening operation of the hand 1 is requested (request ON).

The variable #201 is assigned, for example, to request a closing operation of the hand 1 of the robot 30 from the machine tool control module 200 to the robot control module 300. When the value of the variable #201 is 0, it indicates that the closing operation of the hand 1 is not requested (request OFF), and when the value of the variable #201 is 1, it indicates that the closing operation of the hand 1 is requested (request ON).

The variable #202 is assigned, for example, to request an opening operation of the hand 2 of the robot 30 from the machine tool control module 200 to the robot control module 300. When the value of the variable #202 is 0, it indicates that the opening operation of the hand 2 is not requested (request OFF), and when the value of the variable #202 is 1, it indicates that the opening operation of the hand 2 is requested (request ON).

The variable #203 is assigned, for example, to request a closing operation of the hand 2 of the robot 30 from the machine tool control module 200 to the robot control module 300. When the value of the variable #203 is 0, it indicates that the closing operation of the hand 2 is not requested (request OFF), and when the value of the variable #203 is 1, it indicates that the closing operation of the hand 2 is requested (request ON).

The values of the plurality of variables stored in the variable memory are reset to a predetermined initial value (for example, 0) in response to turning on the numerical control device 2.

Next, the configuration of the robot control device 3 will be described in detail. As shown in FIG. 2, in the robot control device 3, various functions such as the robot control module 300 for controlling the operation of the robot 30, a data transmission/reception unit 35, a signal variable converter 36, a signal variable storage unit 37, etc., are implemented by the above hardware configuration.

The robot control module 300 reads and writes the value of the variable stored in the variable storage unit 24 and controls the operation of the robot 30 based on the robot control program. More specifically, the robot control module 300 includes a storage unit 31, a program input unit 32, an analysis unit 33, a trajectory control unit 38, and a servo control unit 39.

The storage unit 31 stores a robot control program for controlling the operation of the robot 30. The robot control program stored in the storage unit 31 is created by an operator in advance in order to control the operation of the robot 30 in conjunction with the operation of the machine tool 20 under the control of the numerical control device 2.

The program input unit 32 reads the robot control program from the storage unit 31, and sequentially inputs the robot control program to the analysis unit 33.

The analysis unit 33 sequentially analyzes the command type based on the robot control program inputted from the program input unit 32 for each block, and transmits the analysis result to the trajectory control unit 38, the data transmission/reception unit 35, and the signal variable converter 36.

When the type of command acquired based on the robot control program is, for example, a command to move a control point (for example, the arm tip portion 30a) of the robot 30, the analysis unit 33 inputs the acquired command to the trajectory control unit 38. When a command is inputted from the analysis unit 33, the trajectory control unit 38 calculates an operation trajectory of the control point when the control point of the robot 30 is moved to a position designated by the command, calculates an angle of each joint of the robot 30 according to the calculated operation trajectory as a target angle, and transmits these target angles to the servo control unit 39. The servo control unit 39 generates a robot control signal for the robot 30 by feedback-controlling each servo motor of the robot 30 so as to realize the target angle of each of the joints transmitted from the trajectory control unit 38, and inputs the robot control signal to the servo motors of the robot 30. Thus, the operation of the robot 30 is controlled by a procedure determined by the robot control program.

When the type of the command acquired based on the robot control program is, for example, a command to read the value of the variable stored in the variable storage unit 24 or a command to rewrite the value of the variable stored in the variable storage unit 24, the analysis unit 33 inputs the acquired command to the data transmission/reception unit 35.

When receiving a command to read the value of the variable from the analysis unit 33, the data transmission/reception unit 35 transmits the command to the data transmission/reception unit 25 of the numerical control device 2. As described above, when such a read command is inputted, the variable storage unit 24 reads the value of the variable designated by the command from the variable memory, and returns the read value to the analysis unit 33 via the data transmission/reception unit 25 and the data transmission/reception unit 35. When receiving a command to rewrite the value of the variable from the analysis unit 33, the data transmission/reception unit 35 transmits the command to the data transmission/reception unit 25 of the numerical control device 2. As described above, when such a rewrite command is inputted, the variable storage unit 24 rewrites the value of the variable designated by the command in the variable memory to a value corresponding to the command. Thus, the robot control module 300 can read or rewrite the value of the variable stored in the variable memory.

The signal variable converter 36 converts the value of the variable of the numerical control device 2 into a signal or a variable of the robot control device 3. Specifically, the signal variable converter 36 converts the value of the custom macro variable of the numerical control device 2 into a signal or a variable of the robot control device 3.

Here, the signal or variable of the robot control device 3 is a conditional branch signal or a conditional branch variable of the robot 30. That is, the signal variable converter 36 converts the value of the custom macro variable of the numerical control device 2 into a conditional branch signal or a conditional branch variable of the robot 30.

The signal variable storage unit 37 stores the values of the custom macro variables of the numerical control device 2 to be associated with the conditional branch signals or conditional branch variables of the robot.

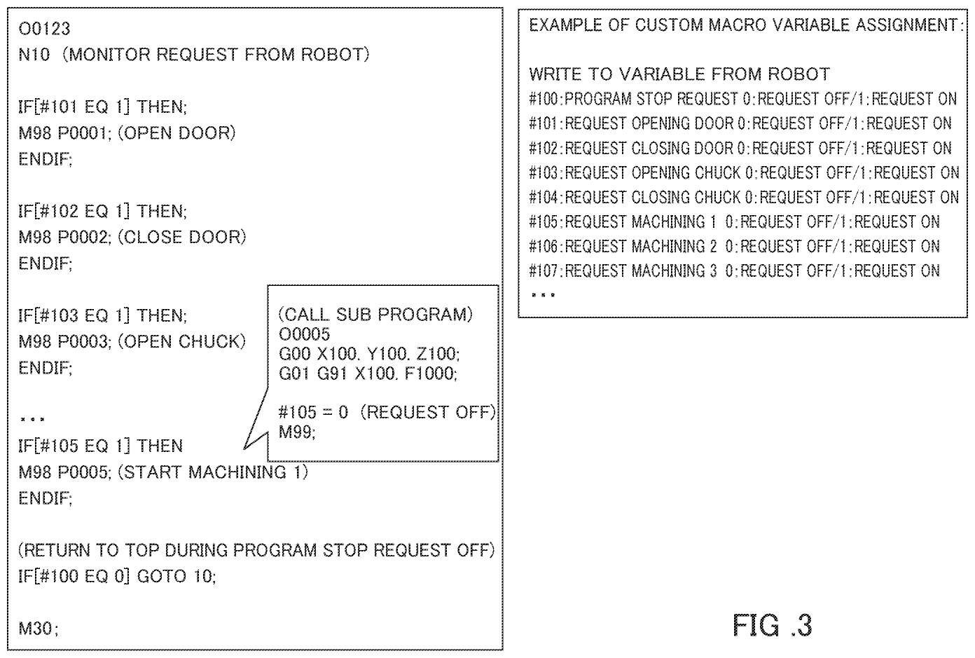

FIG. 3 is a diagram showing an example of a numerical control program according to the present embodiment. FIG. 3 shows, as an example, a numerical control program having a program number 0123, and a sequence number N10 is assigned to the first block. FIG. 3 also shows an example of the assignment of the above-described custom macro variables.

In the numerical control program shown in FIG. 3, the machine tool control module 200 reads the values of the variables #100 to #107 at a predetermined period, thereby monitoring the request from the robot control module 300 and controlling the operation of the machine tool 20 by the machine tool control module 200 in accordance with the read values of the variables #100 to #107.

The robot control module 300 controls the operation of the robot 30 according to the robot control program, and rewrites the values of the variables #100 to #107 stored in the variable memory of the variable storage unit 24 in accordance with the robot control program.

More specifically, in the first block, the machine tool control module 200 reads the value of the variable #101 stored in the variable memory, and determines whether or not the read value is “1”. When the value of the variable #101 is “1”, that is, when the opening operation of the door of the machine tool 20 is requested from the robot control module 300, the machine tool control module 200 calls the subprogram of the program number “0001” according to the command “M98” for calling the subprogram, and when the value of the variable #101 is “0”, the machine tool control module 200 moves to the next block. In addition, the machine tool control module 200 executes the subprogram of the program number “0001” to open the door of the machine tool 20 and reset the value of the variable #101 to “0”, and then returns to the main program shown in FIG. 3. In the next block, the machine tool control module 200 reads the value of the variable #102 stored in the variable memory, and determines whether or not the read value is “1”. When the value of the variable #102 is “1”, that is, when the closing operation of the door of the machine tool 20 is requested from the robot control module 300, the machine tool control module 200 executes the subprogram of the program number “0002”, and when the value of the variable #102 is “0”, the machine tool control module 200 moves to the next block. The machine tool control module 200 closes the door of the machine tool 20 by executing the subprogram of the program number “0002”, resets the value of the variable #102 to “0”, and then returns to the main program shown in FIG. 3.

In the next block, the machine tool control module 200 reads the value of the variable #103 stored in the variable memory, and determines whether or not the read value is “1”. When the value of the variable #103 is “1”, that is, when the chuck opening operation of the machine tool 20 is requested from the robot control module 300, the machine tool control module 200 executes the subprogram of the program number “0003”, and when the value of the variable #103 is “0”, the machine tool control module 200 moves to the next block. The machine tool control module 200 executes the subprogram of the program number “0003” to open the chuck of the machine tool 20 and reset the value of the variable #103 to “0”, and then returns to the main program shown in FIG. 3.

Although not shown, the machine tool control module 200 similarly reads the value of the variable #104 stored in the variable memory, and determines whether or not the read value is “1”. When the value of the variable #104 is “1”, that is, when the closing operation of the chuck of the machine tool 20 is requested from the robot control module 300, the machine tool control module 200 executes the subprogram of the program number “0004”, and when the value of the variable #104 is “0”, the machine tool control module 200 moves to the next block. In addition, the machine tool control module 200 executes the subprogram of the program number “0004” to close the chuck of the machine tool 20 and reset the value of the variable #104 to “0”, and then returns to the main program shown in FIG. 3.

In the next block, the machine tool control module 200 reads the value of the variable #105 stored in the variable memory, and determines whether or not the read value is “1”. The machine tool control module 200 executes the subprogram of the program number “0005” when the value of the variable #105 is “1”, that is, when the robot control module 300 requests the machine tool 20 to perform the operation of the machine tool 1, and shifts to the next block when the value of the variable #105 is “0”.

FIG. 3 shows an example of a subprogram having a program number “0005”. When the subprogram of the program number “0005” is called, the machine tool control module 200 inputs various commands “G00” and “G01” for machining a workpiece by the machine tool 20. The machine tool control module 200 controls the positioning operation, the linear interpolation operation, and the like of the machine tool 20 in accordance with the procedure determined by the numerical control program to machine the workpiece. When the operation of the machining 1 is completed, the machine tool control module 200 rewrites the value of the variable #105 stored in the variable memory to “0”, and returns to the main program shown in FIG. 3 in accordance with the command “M99”.

Although not shown, the operation requests of the machining 2 and the machining 3 by the machine tool 20 from the robot control module 300 are also executed by the numerical control program, similarly to the operation request of the machining 1 described above.

In the next block, the machine tool control module 200 reads the value of the variable #100 stored in the variable memory, and determines whether or not the read value is “0”. When the value of the variable #100 is “0”, that is, when stop of the numerical control program is not requested from the robot control module 300, the machine tool control module 200 returns to the sequence number “N10” and monitors the values of the variables #100 to #107 again. When the value of the variable #100 is “1”, i.e., when the robot control module 300 requests stop of the numerical control program, the machine tool control module 200 ends the numerical control program shown in FIG. 3 in accordance with the command “M30”.

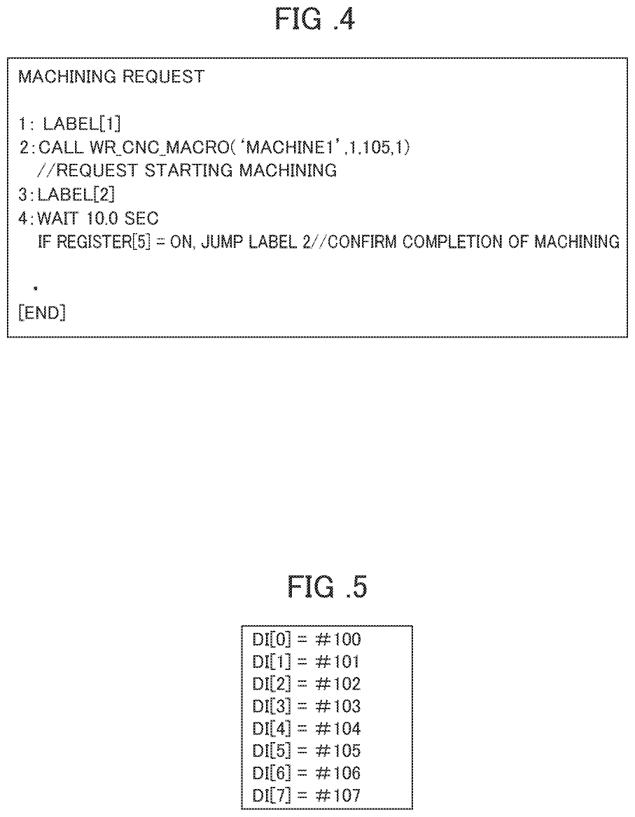

FIGS. 4 to 7 are diagrams showing examples in which the values of the custom macro variables are converted into conditional branch signals of the robot 30. FIG. 4 is a diagram showing an example of a robot control program created from the numerical control program shown in FIG. 3 using a read/write command of a custom macro variable. In the robot control program shown in FIG. 4, the codes of the second and fifth lines are created using a read/write command of a custom macro variable (custom macro variable #105).

In this way, when the robot control program is linked via the custom macro variable of the numerical control device 2, the robot control device 3 needs to create a new robot control program using the custom macro variable of the numerical control device 2. Therefore, the robot control device 3 cannot use the existing robot control program.

In this regard, the robot control device 3 according to the present embodiment converts the value of the custom macro variable of the numerical control device 2 into a conditional branch signal or a conditional branch variable of the robot 30, as described below.

FIG. 5 is a diagram showing a correspondence relationship between conditional branch signals of the robot 30 and values of custom macro variables of the numerical control device 2. As shown in FIG. 5, the conditional branch signals DI[0], DI[1], DI[2], DI[3], DI[4], DI[5], DI[6], and DI[7] of the robot 30 are associated with the custom macro variables #100, #101, #102, #103, #104, #105, #106, and #107, respectively. As described above, the conditional branch signals of the robot 30 and the values of the custom macro variables are stored in the signal variable storage unit 37.

As described above, when the command type of the robot control program is determined by the analysis unit 33 and the command acquired based on the robot control program is a command for instructing reading of the value of the variable stored in the variable storage unit 24, the analysis unit 33 reads the value of the variable stored in the variable storage unit 24.

Then, the signal variable converter 36 converts the read value of the custom macro variable of the numerical control device 2 into a conditional branch signal of the robot 30, based on the conditional branch signal of the robot 30 and the value of the custom macro variable stored in the signal variable storage unit 37.

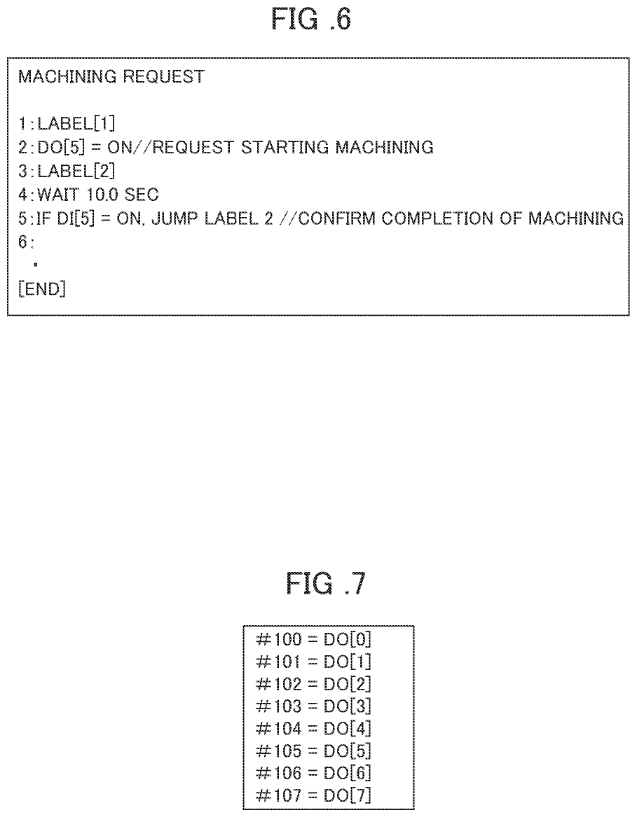

FIG. 6 is an example of a robot control program including the conditional branch signals of the robot 30 converted by the signal variable converter 36. The robot control program shown in FIG. 6 executes control of the robot 30 similar to the robot control program shown in FIG. 4.

In the robot control program shown in FIG. 6, similarly to the robot control program shown in FIG. 4, the codes of the second and fifth lines include conditional branch signals (DO[5] and DI[5]) of the robot 30. However, the values of the custom macro variables of the numerical control device 2 is converted into conditional branch signals of the robot 30. Therefore, the robot control device 3 does not need to change the codes of the second and fifth lines in the existing robot control program. Therefore, it is possible for the robot control device 3 to use the existing robot control program without newly creating a robot control program.

Then, the robot control device 3 controls the operation of the robot 30 using the conditional branch signals of the robot 30 converted by the signal variable converter 36 and the robot control program.

FIG. 7 is a diagram showing a correspondence relationship between values of custom macro variables of the numerical control device 2 and conditional branch signals of the robot 30. As shown in FIG. 7, custom macro variables #100, #101, #102, #103, #104, #105, #106, and #107 are associated with conditional branch signals DO[0], DO[1], DO[2], DO[3], DO[4], DO[5], DO[6], and DO[7], respectively, of the robot 30. As described above, the conditional branch signals of the robot 30 and the values of the custom macro variables are stored in the signal variable storage unit 37.

After the operation of the robot 30 is controlled based on the conditional branch signals of the robot 30 converted by the signal variable converter 36, the signal variable converter 36 converts the conditional branch signals of the robot 30 into the value of the custom macro variable of the numerical control device 2 based on the conditional branch signals of the robot 30 and the values of the custom macro variables stored in the signal variable storage unit 37.

The data transmission/reception unit 35 transmits the converted values of the custom macro variables to the data transmission/reception unit 25. Then, the robot control module 300 updates the values of the custom macro variables stored in the variable memory of the variable storage unit 24 based on the values of the custom macro variables received by the data transmission/reception unit 25.

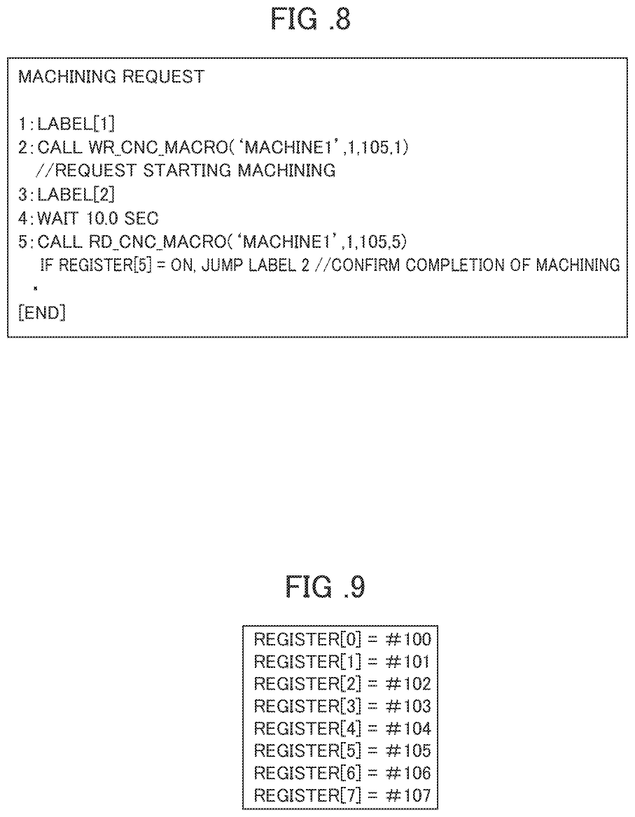

FIGS. 8 to 11 are diagrams showing examples in which the values of the custom macro variables are converted into conditional branch variables of the robot 30. FIG. 8 is a diagram showing an example of a robot control program created from the numerical control program shown in FIG. 3 using a read/write command of a custom macro variable. In the robot control program shown in FIG. 8, the codes of the second line and the fifth line are created using the read/write command of the custom macro variable.

FIG. 9 is a diagram showing a correspondence relationship between the conditional branch variables of the robot 30 and the values of the custom macro variables of the numerical control device 2. As shown in FIG. 9, the conditional branch variables register[0], register[1], register[2], register[3], register[4], register[5], register[6], and register[7] of the robot 30 are associated with the custom macro variables #100, #101, #102, #103, #104, #105, #106, and #107, respectively. As described above, the conditional branch variables of the robot 30 and the values of the custom macro variables are stored in the signal variable storage unit 37.

As described above, when the command type of the robot control program is determined by the analysis unit 33 and the command acquired based on the robot control program is a command for instructing reading of the value of the variable stored in the variable storage unit 24, the analysis unit 33 reads the value of the variable stored in the variable storage unit 24.

Then, the signal variable converter 36 converts the read value of the custom macro variable of the numerical control device 2 into the conditional branch variable of the robot 30, based on the conditional branch variable of the robot 30 and the custom macro variable stored in the signal variable storage unit 37.

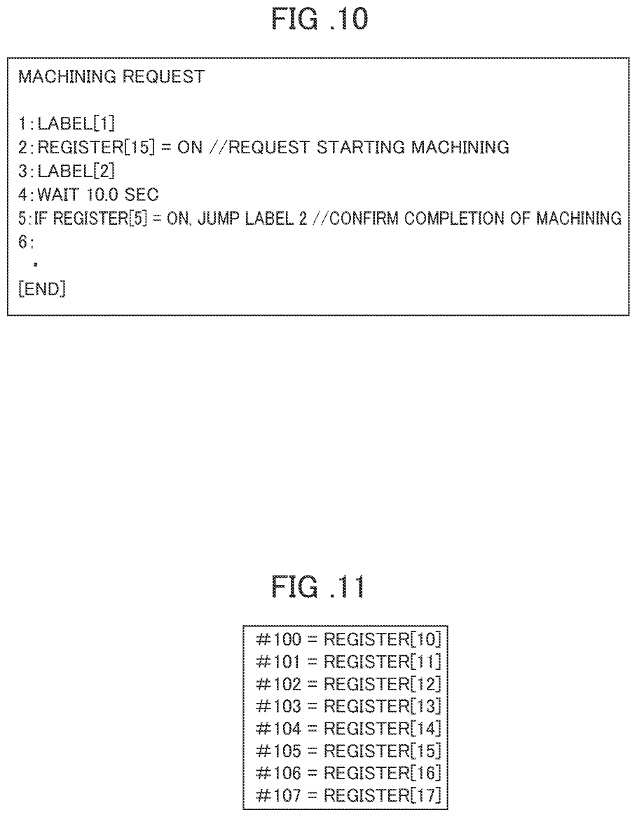

FIG. 10 is an example of a robot control program including conditional branch variables of the robot 30 converted by the signal variable converter 36. The robot control program shown in FIG. 10 executes control of the robot 30 similar to the robot control program shown in FIG. 8.

In the robot control program shown in FIG. 10, similar to the robot control program shown in FIG. 8, the codes of the second and fifth lines include conditional branch variables (register[15] and register[5]) of the robot 30. However, the values of the custom macro variable of the numerical control device 2 have been converted into conditional branch variables of the robot 30. Therefore, the robot control device 3 does not need to change the codes of the second and fifth lines in the existing robot control program.

Then, the robot control device 3 controls the operation of the robot 30 using the conditional branch variables of the robot 30 converted by the signal variable converter 36 and the robot control program.

FIG. 11 is a diagram showing the correspondence relationship between the values of the custom macro variables of the numerical control device 2 and the conditional branch variables of the robot 30. As shown in FIG. 11, the custom macro variables #100, #101, #102, #103, #104, #105, #106, and #107 are associated with the conditional branch variables register[10], register[11], register[12], register[13], register[14], register[15], register[16], and register[17] of the robot 30, respectively. As described above, the values of the conditional branch variables of the robot 30 and the custom macro variables are stored in the signal variable storage unit 37.

After the operation of the robot 30 is controlled based on the conditional branch variable of the robot 30 converted by the signal variable converter 36, the signal variable converter 36 converts the conditional branch variable of the robot 30 into the value of the custom macro variable of the numerical control device 2 based on the conditional branch variable of the robot 30 and the value of the custom macro variable stored in the signal variable storage unit 37.

The data transmission/reception unit 35 transmits the converted value of the custom macro variable to the data transmission/reception unit 25. Then, the robot control module 300 updates the value of the custom macro variable stored in the variable memory of the variable storage unit 24 based on the value of the custom macro variable received by the data transmission/reception unit 25.

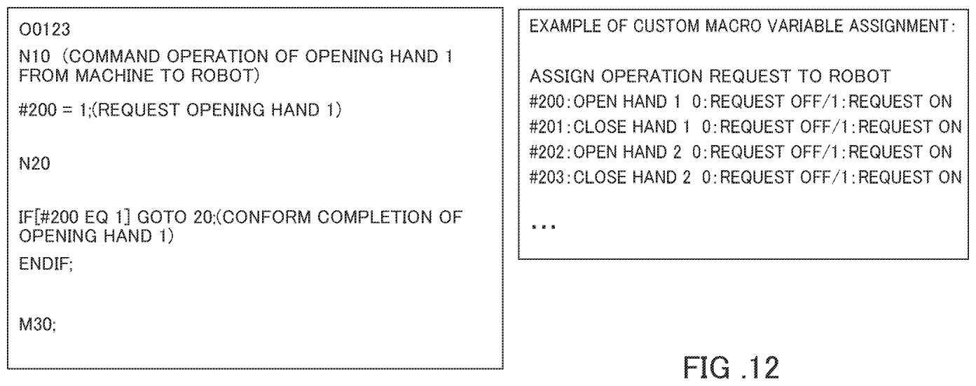

FIG. 12 is a diagram showing another example of the numerical control program according to the present embodiment.

FIG. 12 shows, as an example, a numerical control program having a program number 0123, and a sequence number N10 is assigned to the first block. FIG. 12 also shows an example of assignment of the above-described custom macro variables.

The numerical control program shown in FIG. 12 monitors a request from the robot control module 300 by reading the values of the variables #200 to #203 and the like at a predetermined period in the machine tool control module 200, and controls the operation of the machine tool 20 by the machine tool control module 200 in accordance with the read values of the variables #200 to #203.

The robot control module 300 controls the operation of the robot 30 in accordance with the robot control program, and rewrites the values of the variables #200 to #203 stored in the variable memory of the variable storage unit 24 in accordance with the robot control program.

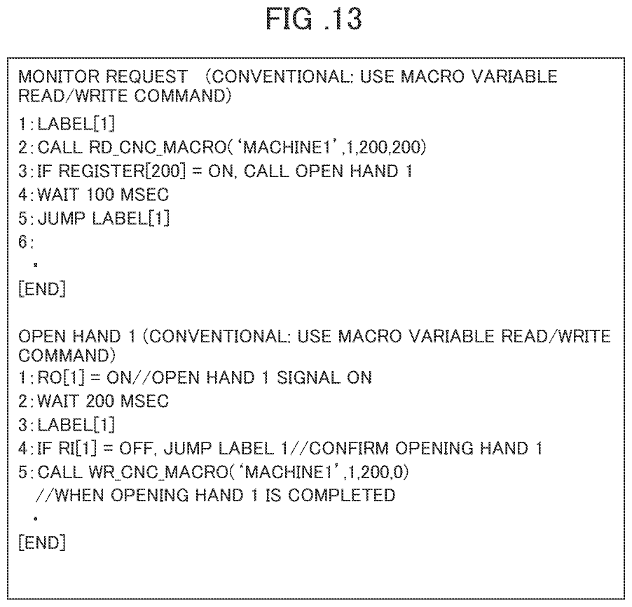

FIGS. 13 to 16 are diagrams respectively showing an example in which the values of the custom macro variable are converted into conditional branch signals of the robot 30. FIG. 13 is a diagram showing an example of a robot control program created from the numerical control program shown in FIG. 12 using a read/write command of a custom macro variable. In the robot control program shown in FIG. 13, the codes of the second and third lines in the upper row and the code of the fifth line in the lower row are generated using a read/write command of a custom macro variable.

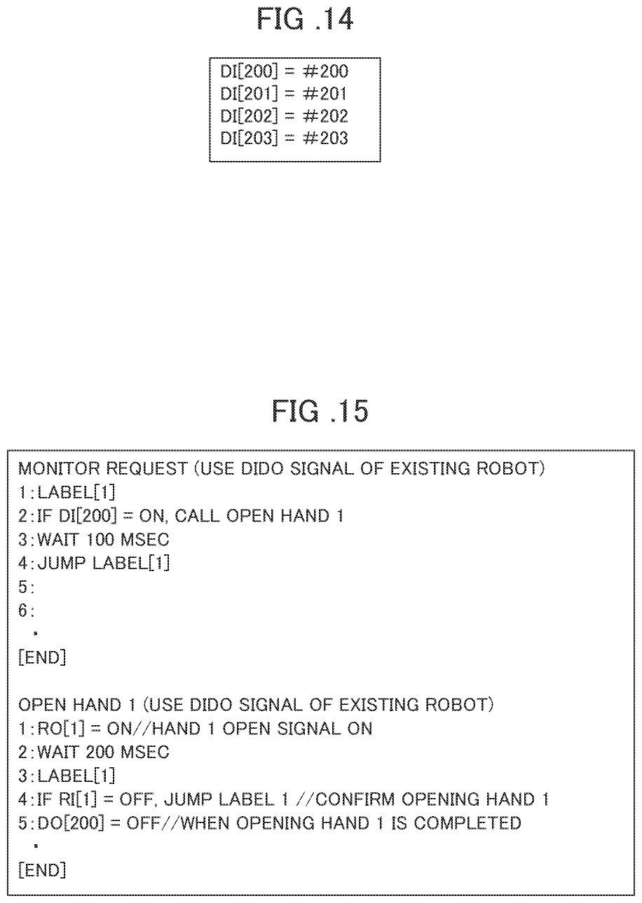

FIG. 14 is a diagram showing a correspondence relationship between the conditional branch signals of the robot 30 and the values of the custom macro variables of the numerical control device 2. As shown in FIG. 14, the conditional branch signals DI[200], DI[201], DI[202], and DI[203] of the robot 30 are associated with the custom macro variables #200, #201, #202, and #203, respectively. As described above, the conditional branch signals of the robot 30 and the values of the custom macro variables are stored in the signal variable storage unit 37.

As described above, when the command type of the robot control program is determined by the analysis unit 33 and the command acquired based on the robot control program is a command for instructing reading of the value of the variable stored in the variable storage unit 24, the analysis unit 33 reads the value of the variable stored in the variable storage unit 24.

Then, the signal variable converter 36 converts the read value of the custom macro variable of the numerical control device 2 into a conditional branch signal of the robot 30, based on the conditional branch signal of the robot 30 and the value of the custom macro variable stored in the signal variable storage unit 37.

FIG. 15 is an example of a robot control program including a conditional branch signal of the robot 30 converted by the signal variable converter 36. The robot control program shown in FIG. 15 executes control of the robot 30 similar to the robot control program shown in FIG. 13.

In the robot control program shown in FIG. 15, similarly to the robot control program shown in FIG. 13, the code of the second line in the upper row and the code of the fifth line in the lower row include conditional branch signals (DI[200] and DO[200]) of the robot 30. However, the value of the custom macro variable of the numerical control device 2 is converted into a conditional branch signal of the robot 30. Therefore, the robot control device 3 does not need to change the code of the second line in the upper row and the code of the fifth line in the lower row in the existing robot control program.

Then, the robot control device 3 controls the operation of the robot 30 using the conditional branch signal of the robot 30 converted by the signal variable converter 36 and the robot control program.

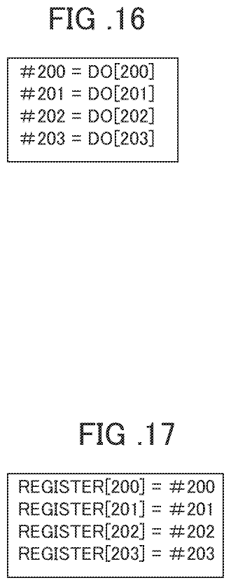

FIG. 16 is a diagram showing a correspondence relationship between values of custom macro variables of the numerical control device 2 and conditional branch signals of the robot 30. As shown in FIG. 16, custom macro variables #200, #201, #202 and #203 are associated with conditional branch signals DO[200], DO[201] and DO[202] of the robot 30, respectively. As described above, the conditional branch signals of the robot 30 and the values of the custom macro variables are stored in the signal variable storage unit 37.

After the operation of the robot 30 is controlled based on the conditional branch signal of the robot 30 converted by the signal variable converter 36, the signal variable converter 36 converts the conditional branch signal of the robot 30 into the value of the custom macro variable of the numerical control device 2, based on the conditional branch signal of the robot 30 and the value of the custom macro variable stored in the signal variable storage unit 37.

The data transmission/reception unit 35 transmits the converted value of the custom macro variable to the data transmission/reception unit 25. Then, the robot control module 300 updates the value of the custom macro variable stored in the variable memory of the variable storage unit 24 based on the value of the custom macro variable received by the data transmission/reception unit 25.

FIGS. 17 to 19 are diagrams respectively showing an example in which the value of the custom macro variable is converted into a conditional branch variable of the robot 30.

FIG. 17 is a diagram showing a correspondence relationship between the conditional branch variables of the robot 30 and the values of the custom macro variables of the numerical control device 2. As shown in FIG. 17, the conditional branch variables of register[200], register[201], register[202], and register[203] of the robot 30 are associated with the custom macro variables #200, #201, #202, and #203, respectively. As described above, the values of the conditional branch variables and the custom macro variables of the robot 30 are stored in the signal variable storage unit 37.

As described above, when the command type of the robot control program is determined by the analysis unit 33 and the command acquired based on the robot control program is a command for instructing reading of the value of the variable stored in the variable storage unit 24, the analysis unit 33 reads the value of the variable stored in the variable storage unit 24.

Then, the signal variable converter 36 converts the read value of the custom macro variable of the numerical control device 2 into a conditional branch variable of the robot 30, based on the conditional branch variable of the robot 30 and the custom macro variable stored in the signal variable storage unit 37.

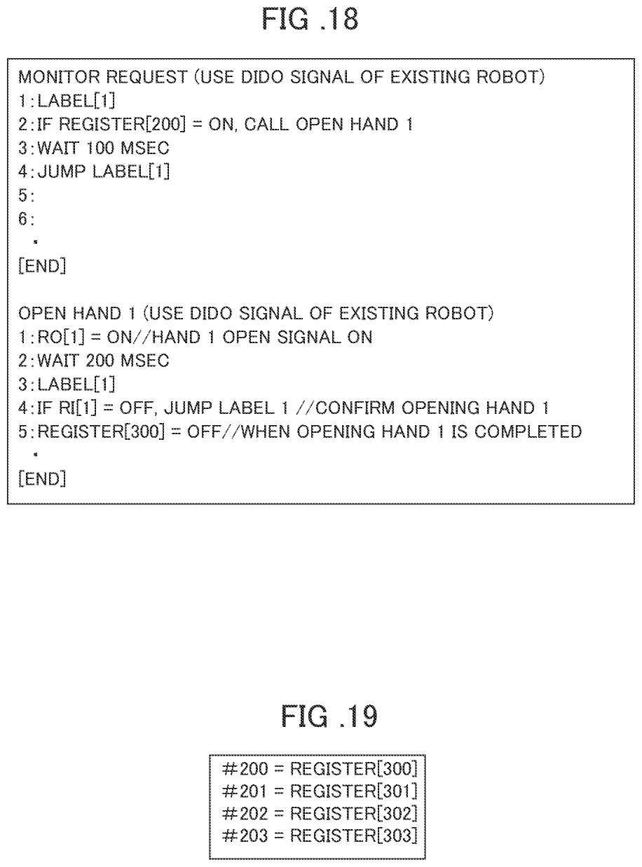

FIG. 18 is an example of a robot control program including conditional branch variables of the robot 30 converted by the signal variable converter 36. The robot control program shown in FIG. 18 executes control of the robot 30 similar to the robot control program shown in FIG. 13.

In the robot control program shown in FIG. 18, similarly to the robot control program shown in FIG. 13, the code of the second line in the upper row and the code of the fifth line in the lower row include conditional branch variables (register[200] and register[300]) of the robot 30. However, the values of the custom macro variable of the numerical control device 2 are converted into conditional branch variables of the robot 30. Therefore, the robot control device 3 does not need to change the code of the second line in the upper row and the code of the fifth line in the lower row in the existing robot control program.

Then, the robot control device 3 controls the operation of the robot 30 using the conditional branch variable and the robot control program of the robot 30 converted by the signal variable converter 36.

FIG. 19 is a diagram showing the correspondence relationship between the values of the custom macro variables of the numerical control device 2 and the conditional branch variables of the robot 30. As shown in FIG. 19, custom macro variables #200, #201, #202, and #203 are associated with conditional branch variables of register[300], register[301], register[302], and register[303] of the robot 30, respectively. As described above, the values of the conditional branch variables and the custom macro variables of the robot 30 are stored in the signal variable storage unit 37.

After the operation of the robot 30 is controlled based on the conditional branch variable of the robot 30 converted by the signal variable converter 36, the signal variable converter 36 converts the conditional branch variable of the robot 30 into the value of the custom macro variable of the numerical control device 2 based on the conditional branch variable of the robot 30 and the value of the custom macro variable stored in the signal variable storage unit 37.

The data transmission/reception unit 35 transmits the converted value of the custom macro variable to the data transmission/reception unit 25. Then, the robot control module 300 updates the value of the custom macro variable stored in the variable memory of the variable storage unit 24 based on the value of the custom macro variable received by the data transmission/reception unit 25.

In the embodiment described above, the signal variable converter 36 converts the value of the custom macro variable of the numerical control device 2 into either the conditional branch signal or the conditional branch variable of the robot 30. However, when the robot control program includes both the conditional branch signal and the conditional branch variable of the robot 30, the signal variable converter 36 may convert the value of the custom macro variable of the numerical control device 2 into the conditional branch signal and the conditional branch variable of the robot 30.

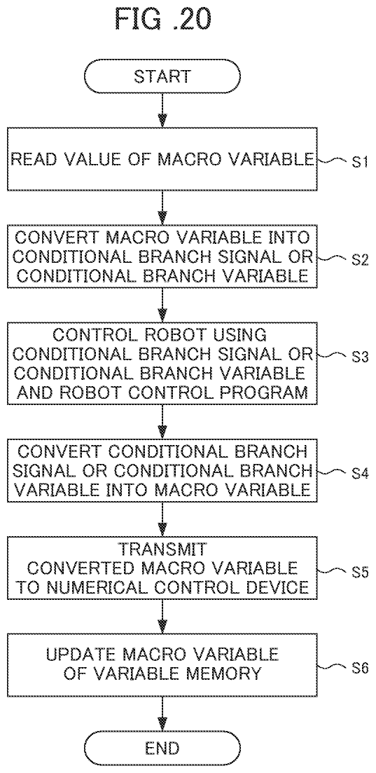

FIG. 20 is a flowchart showing a flow of processing for converting a value of a custom macro variable of the numerical control device 2 into a signal or a variable of the robot control device 3 in the numerical control system 1 according to the present embodiment.

In Step S1, when the instruction type of the robot control program is determined by the analysis unit 33, and the instruction acquired based on the robot control program is a command for instructing reading of the value of the custom macro variable stored in the variable storage unit 24, the analysis unit 33 reads the value of the custom macro variable stored in the variable storage unit 24.

In Step S2, the signal variable converter 36 converts the read value of the custom macro variable of the numerical control device 2 into the conditional branch signal or conditional branch variable of the robot 30, based on the conditional branch signal or conditional branch variable of the robot 30 and the value of the custom macro variable stored in the signal variable storage unit 37.

In Step S3, the robot control device 3 controls the operation of the robot 30 using the conditional branch signal or conditional branch variable of the robot 30 converted by the signal variable converter 36, and the robot control program.

In Step S4, the signal variable converter 36 converts the conditional branch signal or conditional branch variable of the robot 30 into the value of the custom macro variable of the numerical control device 2, based on the conditional branch signal or conditional branch variable of the robot 30 and the value of the custom macro variable stored in the signal variable storage unit 37.

In Step S5, the data transmission/reception unit 35 transmits the converted value of the custom macro variable to the data transmission/reception unit 25. In Step S6, the robot control module 300 updates the value of the custom macro variable stored in the variable memory of the variable storage unit 24 based on the value of the custom macro variable received by the data transmission/reception unit 25.

According to the present embodiment, the following advantageous effects are achieved. The numerical control system 1 that controls operation of the machine tool 20 and operation of the robot 30 in conjunction with each other, includes: the numerical control device 2 that controls the operation of the machine tool 20 based on a numerical control program; the robot control device 3 that controls the operation of the robot 30 based on a robot control program; the variable storage unit 24 that stores a value of a variable that is readable and writable by the numerical control device 2; and the signal variable converter 36 that converts the value of the variable of the numerical control device 2 to a signal or a variable of the robot control device 3. The robot control device 3 reads the value of the variable of the numerical control device stored in the variable storage unit 24, the signal variable converter 36 converts the read value of the variable of the numerical control device 2 to a signal or a variable of the robot control device 3, and the robot control device 3 controls the operation of the robot 30 based on the converted signal or the converted variable of the robot control device 3. With such a configuration, it is possible for the robot control device 3 of the numerical control system 1 to use the existing robot control program without newly creating a robot control program.

The signals or variables of the robot control device 3 are conditional branch signals or conditional branch variables of the robot 30. With such a configuration, it is possible for the numerical control system 1 to use the existing robot control program including the conditional branch signals or conditional branch variables of the robot 30.

Further, the numerical control system 1 further includes the signal variable storage unit 37 that stores the value of the variable of the numerical control device 2 and the conditional branch signal or conditional branch variable of the robot 30 in association with each other, whereby it is possible for the numerical control system 1 to convert the read value of the variable of the numerical control device 2 into the signal or variable of the robot control device 3.

Further, the robot control program includes a conditional branch signal or a conditional branch variable of the robot 30. With such a configuration, it is possible for the numerical control system 1 to use the existing robot control program including the conditional branch signal or conditional branch variable of the robot 30.

Further, the signal variable converter 36 converts the signal or the variable of the robot control device 3 to the value of the variable of the numerical control device 2, the robot control device 3 transmits the converted value of the variable of the numerical control device 2 to the variable storage unit 24, and the numerical control device 2 updates the variable storage unit 24 using the transmitted value of the variable of the numerical control device 2. With such a configuration, it is possible for the numerical control system 1 to convert the signal or the variable of the robot control device 3 to the value of the variable of the numerical control device 2, and update the variable storage unit 24 using the converted value of the variable.

The present disclosure is not limited to the above embodiments, and various changes and modifications are possible.

For example, in the above embodiments, the variable storage unit 24 for storing the values of the plurality of variables that can be read and written from both the machine tool control module 200 and the robot control module 300 is provided in the numerical control device 2. However, the present invention is not limited thereto.

The variable storage unit may be provided, for example, in a robot control device communicably connected to the numerical control device. In this case, since the machine tool control module of the numerical control device can read and write the values of the variables stored in the variable storage unit provided in the robot control device via the communication, it is possible to achieve the same advantageous effect as in the above embodiment.

Further, the variable storage unit may be provided, for example, in a server communicably connected to each of the numerical control device and the robot control device. In this case, since the machine tool control module of the numerical control device and the robot control module of the robot control device can read and write the values of variables stored in the variable storage unit provided in the server via the communication, it is possible to achieve the same advantageous effect as in the above embodiment.

### EXPLANATION OF REFERENCE NUMERALS

1 numerical control system
2 numerical control device
3 robot control device
20 machine tool
21 storage unit
22 program input unit
23 analysis unit
24 variable storage unit
25 data transmission/reception unit
26 I/O control unit
27 interpolation control unit
28 servo control unit
30 robot
30a arm tip portion
30b tool
31 storage unit
32 program input unit
33 analysis unit
35 data transmission/reception unit
36 signal variable converter
37 signal variable storage unit
38 trajectory control unit
39 servo control unit
200 machine tool control module
300 robot control module

1. A numerical control system that controls operation of a machine tool and operation of a robot in conjunction with each other, the numerical control system comprising:
a numerical control device that controls the operation of the machine tool based on a numerical control program;
a robot control device that controls the operation of the robot based on a robot control program;
a variable storage unit that stores a value of a variable that is readable and writable by the numerical control device; and
a signal variable converter that converts the value of the variable of the numerical control device to a signal or a variable of the robot control device, wherein
the robot control device reads the value of the variable of the numerical control device stored in the variable storage unit,
the signal variable converter converts the value of the variable of the numerical control device read to a signal or a variable of the robot control device, and
the robot control device controls the operation of the robot based on the converted signal or the converted variable of the robot control device.

2. The numerical control system according to according to claim 1, wherein the signal or the variable of the robot control device is a conditional branch signal or a conditional branch variable of the robot.

3. The numerical control system according to claim 2, further comprising a signal variable storage unit that stores the value of the variable of the numerical control device and the conditional branch signal or the conditional branch variable of the robot to be associated with each other.

4. The numerical control system according to claim 2 or 3, wherein the robot control program includes the conditional branch signal or the conditional branch variable of the robot.

5. The numerical control system according to any one of claims 1 to 4, wherein
the signal variable converter converts the signal or the variable of the robot control device to the value of the variable of the numerical control device,
the robot control device transmits the converted value of the variable of the numerical control device to the variable storage unit, and
the numerical control device updates the variable storage unit using the transmitted value of the variable of the numerical control device.

6. A robot control device that controls operation of a machine tool and operation of a robot in conjunction with each other based on a robot control program, the robot control device comprising:
a signal variable converter that converts a value of a variable of the numerical control device that controls the operation of the machine tool based on a numerical control program into a signal or a variable of the robot control device,
wherein the robot control device reads the value of the variable of the numerical control device from the numerical control device,
the signal variable converter converts the read value of the variable of the numerical control device into a signal or a variable of the robot control device, and
the robot control device controls the operation of the robot based on the signal converted or the variable converted of the robot control device.

7. The robot control device according to claim 6, wherein
the signal variable converter converts the signal or the variable of the robot control device into the value of the variable of the numerical control device,
the robot control device transmits the value converted of the variable of the numerical control device to a variable storage unit, and
the numerical control device updates the variable storage unit using the value transmitted of the variable of the numerical control device.
